(19) United States
(12) Patent Application Publication
(10) Pub. No.: US 2024/0353052 A1
(43) Pub. Date: Oct. 24, 2024

(54) MONITOR MOUNT WITH SIDE-ACCESSIBLE HEIGHT-ADJUSTMENT MECHANISM

(71) Applicant: Bestqi Innovation Technology (Shenzhen) Co., Ltd., Shenzhen (CN)

(72) Inventors: Cheng LIU, Shenzhen (CN); Haijian WU, Shenzhen (CN); Junhua PENG, Shenzhen (CN); Chengan LU, Shenzhen (CN); Tong CHEN, Shenzhen (CN); Ling HUANG, Shenzhen (CN); Changgan SHEN, Shenzhen (CN); Yuan WANG, Shenzhen (CN)

(73) Assignee: Bestqi Innovation Technology (Shenzhen) Co., Ltd., Shenzhen, GD (CN)

(21) Appl. No.: 18/645,102

(22) Filed: Apr. 24, 2024

(30) Foreign Application Priority Data
Apr. 24, 2023 (CN) 202320955168.2
Sep. 4, 2023 (CN) 202322397009.8

(51) Int. Cl. F16M 11/04; F16M 13/02

(52) U.S. Cl. CPC F16M 11/046; F16M 13/02

(57) ABSTRACT

The present disclosure relates to a system for mounting a display on a wall. The system may include at least one hanger assembly arranged in a vertical direction. The hanger assembly includes a hook assembly configured to engage a wall panel and a movable hanger configured to slidably engage with the hook assembly such that the movable hanger slides in a vertical direction. The system may further include an adjustment assembly having at least one adjustment component and an adjustment actuator. The adjustment component includes an abutment surface configured to slidably engage with a support surface of the hook assembly. The adjustment actuator engages the at least one adjustment component such that the adjustment actuator translates in a direction transverse to the vertical direction to drive the adjustment component to also translate in the transverse direction relative to the movable hanger and the movable hanger to translate in the vertical direction.

### CROSS-REFERENCE TO RELATED APPLICATIONS

This application claims priority to, and hereby incorporates by reference the entirety of, Chinese utility model patent application no. 202320955168.2 filed on Apr. 24, 2023, and Chinese utility model patent application 202322397009.8 filed on Sep. 4, 2023.

### TECHNICAL FIELD

This invention relates to a device, system, and method for mounting a display.

### BACKGROUND

A hanging rack is a device used to mount a display or television that allows it to be hung on a wall.

In related technologies, most television hanging racks include a wall panel and two suspension devices. Among them, the wall panel is used to be installed on the wall, and the two suspension devices are connected to the wall panel—one left and one right—and are used to connect the television. However, during the actual installation process of the wall panel, the wall panel may tilt due to installation errors, causing the suspension device to tilt, which in turn causes the television to tilt after being installed on the suspension device, affecting the user experience.

Currently, for most television hanging racks, if the wall panel is installed at an angle, the commonly used method is to disassemble and reinstall the wall panel, which is cumbersome to operate.

### SUMMARY

In certain examples, a system for mounting a display includes at least one hanger assembly arranged in a vertical direction. The hanger assembly includes a hook assembly configured to engage a wall panel, the hook assembly having a support surface extending in a first direction; and a movable hanger configured to slidably engage with the hook assembly, such that the movable hanger slides in a vertical direction, and wherein the movable hanger is configured to receive the display. The system includes an adjustment assembly having at least one adjustment component, the adjustment component including an abutment surface configured to slidably engage with the support surface of the hook assembly; and an adjustment actuator that engages the at least one adjustment component, such that when actuated, the adjustment actuator translates in a direction transverse to the vertical direction to drive the adjustment component to also translate in the transverse direction relative to the movable hanger and the movable hanger to translate in the vertical direction, wherein when the adjustment component is driven the abutment surface of the adjustment component slides along the support surface in the first direction.

In certain examples, a system for mounting a display includes at least one hanging arm component arranged in a vertical direction for hanging on a wall panel; an adjustment component configured to control a vertical adjustment of the hanging arm component, the adjustment component including an adjustment actuator coupled to the hanging arm component, a lifting part that is driven and matched with an adjustment actuator and at least one vertical adjustment component; and an installation component configured to couple to the display device, wherein the installation component is driven by the vertical adjustment component as the lifting part engages the adjustment actuator and drives translation of the vertical adjustment component, wherein, at least one of the lifting part and vertical adjustment component and the at least one vertical adjustment component has a guide wall, wherein the lifting part and vertical adjustment component and the at least one vertical adjustment component are guided and cooperated by the guide wall, wherein the extension direction of the guide wall intersects with a vertical direction and is not vertical, and wherein vertical adjustment component and the at least one vertical adjustment component can be driven by the adjustment actuator to move along the extension direction of the guide wall relative to the lifting part such that vertical adjustment component and the at least one vertical adjustment component moves in the vertical direction relative to the hanging arm component.

In certain examples, a method for adjusting a vertical height of a movable hanger on a wall includes providing a system for mounting a display on a wall. The system includes at least one hanger assembly arranged in a vertical direction; and an adjustment assembly, the adjustment assembly having one or more adjustment components including an abutment surface extending in a first direction; and an adjustment actuator, the adjustment actuator configured to extend along a direction transverse to the vertical direction, wherein the one or more adjustment components are slidably engaged to the movable hanger and abut the hook assembly. The method further includes slidably engaging the movable hanger to abut the hook assembly, using the adjustment actuator; and driving one or more adjustment components to move relative to the hook assembly in the first direction to slide the movable hanger relative to the hook assembly in the vertical direction.

Additional embodiments are disclosed herein.

### BRIEF DESCRIPTION OF THE DRAWINGS

The foregoing Summary and the following Detailed Description will be better understood when read in conjunction with the appended drawings. In the drawings:

FIG. 1 is a perspective view of a schematic representation of a panel-panel-hanging device provided by an example of the first aspect of the present disclosure;

FIG. 2 is an exploded-view schematic diagram of the panel-panel-hanging device shown in FIG. 1;

FIG. 3 is a front view of a portion of the panel-hanging device shown in FIG. 1;

FIG. 4 is a rear view of a portion of the panel-hanging device shown in FIG. 1;

FIG. 5 is a perspective view of a schematic representation of a display mount using the panel-hanging device shown in FIG. 1 provided by an example of the second aspect of the present disclosure;

FIG. 6 is a perspective view of a schematic representation of another embodiment of a panel-hanging device provided by another example of the first aspect of the present disclosure;

FIG. 7 is a front view of a portion of the panel-hanging device shown in FIG. 6;

FIG. 8 is a rear view of a portion of the panel-hanging device shown in FIG. 6;

FIG. 9 is a perspective view of a schematic representation of a display mount using the panel-hanging device shown in FIG. 6 provided by another example of the second aspect of the present disclosure;

FIG. 10 is a schematic diagram of the hook assembly and adjustment component of a panel-hanging device provided by an example of the first aspect of the present disclosure;

FIG. 11 is a schematic diagram of the hook assembly and adjustment component of a panel-hanging device provided by another example of the first aspect of the present disclosure;

FIG. 12 is a schematic view of a television hanging rack according to an example of the present disclosure;

FIG. 13 is a schematic structural diagram of a suspension device according to an example of the present disclosure;

FIG. 14 is a schematic cross-sectional structural diagram of the first section of the figure shown in FIG. 13;

FIG. 15 is an enlarged view of area A in FIG. 14;

FIG. 16 is a schematic cross-sectional structural diagram of the second section of the figure shown in FIG. 13;

FIG. 17 is an enlarged view of area B in FIG. 16;

FIG. 18 is a schematic structural diagram of an adjustment component of an example of the present disclosure;

FIG. 19 is a schematic structural diagram of the first lifting part, the second lifting part and the vertical adjustment component of an example of the present disclosure;

FIG. 20 is a schematic structural diagram of the first lifting part, the second lifting part and the vertical adjustment component of another example of the present disclosure;

FIG. 21 is a schematic structural diagram of the lifting part and the vertical adjustment component of another example of the present disclosure;

FIG. 22 is a schematic structural diagram of the lifting part and the vertical adjustment component of yet another example of the present disclosure.

### DETAILED DESCRIPTION

Examples of the present disclosure are described in detail below, examples of which are shown in the accompanying drawings, wherein the same or similar numerals throughout represent the same or similar elements or elements having the same or similar functions. The examples described below with reference to the accompanying drawings are exemplary and are only used to explain the present disclosure and are not to be understood as limitations on the present disclosure.

In the description of the present disclosure, it should be understood that orientation descriptions, such as the orientation or position relationships indicated by above, below, left, right, etc., are based on the orientation or position relationships shown in the attached drawings and are only to facilitate the description of the present disclosure and simplify the description, not to indicate or imply that the device or element indicated must have a specific orientation or be constructed and operated in a specific orientation, so they cannot be construed as limitations on the present disclosure.

In the description of the present disclosure, unless otherwise expressly defined, terms such as setting, mounting, and connection should be understood broadly. Those skilled in the art can reasonably determine the specific meaning of the above words in the present disclosure in combination with the specific contents of the technical solution.

In the description of the present disclosure, the reference terms “an example,” “some examples,” etc. mean that the specific characteristics, structures, materials, or features described in connection with the example or typical example are included in at least one example or typical example of the present disclosure. In the present specification, schematic representations of the above terms do not necessarily refer to the same example or typical example. Moreover, the specific characteristics, structures, materials, or features described may be combined in any one or more examples or examples in a suitable manner.

In the description of the present disclosure, it should be understood that the terms “center”, “longitudinal”, “lateral”, “length”, “width”, “thickness”, “upper”, “lower”, “front”, “back”, “left”, “right”, “vertical”, “horizontal”, “top”, “bottom”, “inner”, “outer”, “axis”, “radial”, “circumferential” and other indicated orientations or positional relationships are based on the orientations or positional relationships shown in the drawings. They are only for the convenience of describing the present disclosure and simplifying the description. They are not intended to indicate or imply that the device or element referred to must have a specific orientation. The orientation structure and operation of the invention should not be construed as limitations of the present disclosure. In addition, features qualified with “first” and “second” may explicitly or implicitly include one or more of these features. In the description of the present disclosure, unless otherwise stated, the meaning of “multiple” is two or more.

In the description of the present disclosure, it should be noted that, unless otherwise explicitly stipulated and limited, the terms “installation,” “connected,” and “connection” should be understood in a broad sense. For example, it can be a fixed connection, a detachable connection, or an integral connection; it can be a mechanical connection or an electrical connection; it can be directly connected, or it can be indirectly connected through an intermediary, or it can be an internal connection between two components. For those of ordinary skill in the art, the specific meanings of the above terms in the present disclosure can be understood in specific situations.

Examples of the present disclosure are described in detail below. Examples of the typical examples are shown in the drawings, wherein the same or similar reference numerals throughout represent the same or similar elements or elements with the same or similar functions. The examples described below with reference to the drawings are exemplary and are only used to explain the present disclosure and cannot be understood as limitations of the present disclosure.

The television mount typically includes a wall panel (sometimes referred to as a wall plate) and a panel-hanging device, wherein the wall panel is mounted on a wall, a television is mounted to the panel-hanging device, and the panel-hanging device is hung on or snap-connected to the wall panel to enable the mounting of the television. There may be certain errors in the mounting of wall panels, resulting in the tilting of the edge of the snap edge of the wall panel used for snap-connecting the panel-hanging device 100, which in turn causes the television to be tilted, uneven, or asymmetrical after mounting, affecting the user's use. In some examples in this field, an adjustment piece can be provided at the top of a panel-hanging device and the height of the top end of the panel-hanging device or display can be adjusted by pushing out and retracting the adjustment piece to reduce or counteract the impact of improper vertical tilt of a wall panel, thereby improving the levelness of the television. However, the adjustment piece provided on the top of a panel-hanging device would in that circumstance require extending one's hand from the top of the television to the back of the television during adjustment, which is an inconvenient operation. It is therefore desirable to adjust various mounting parameters of a display mount more conveniently from the side of the mount, to avoid having to extend one's hand from the top or bottom of the television to the back of the television during adjustment.

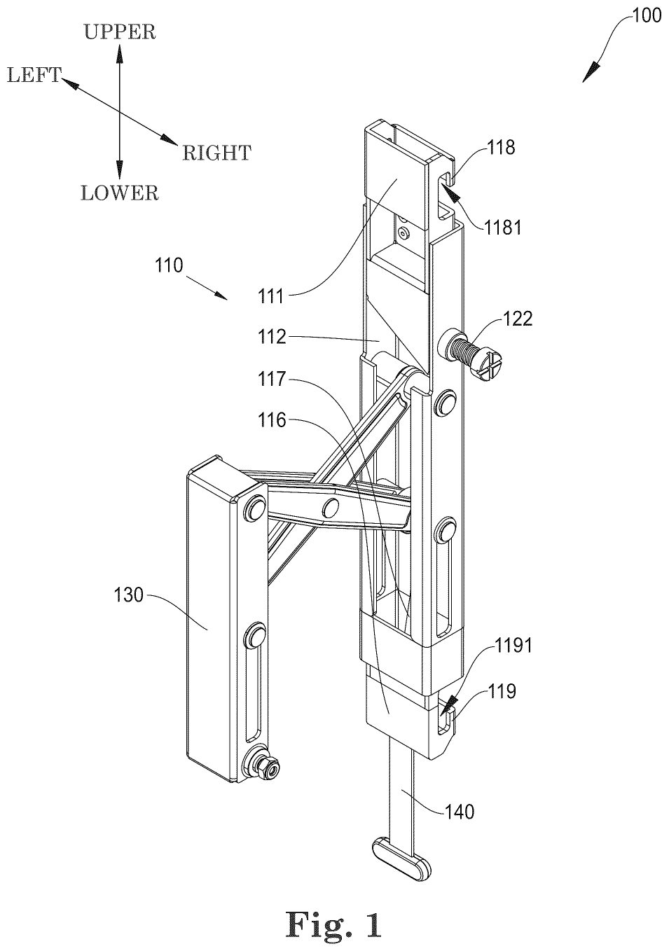

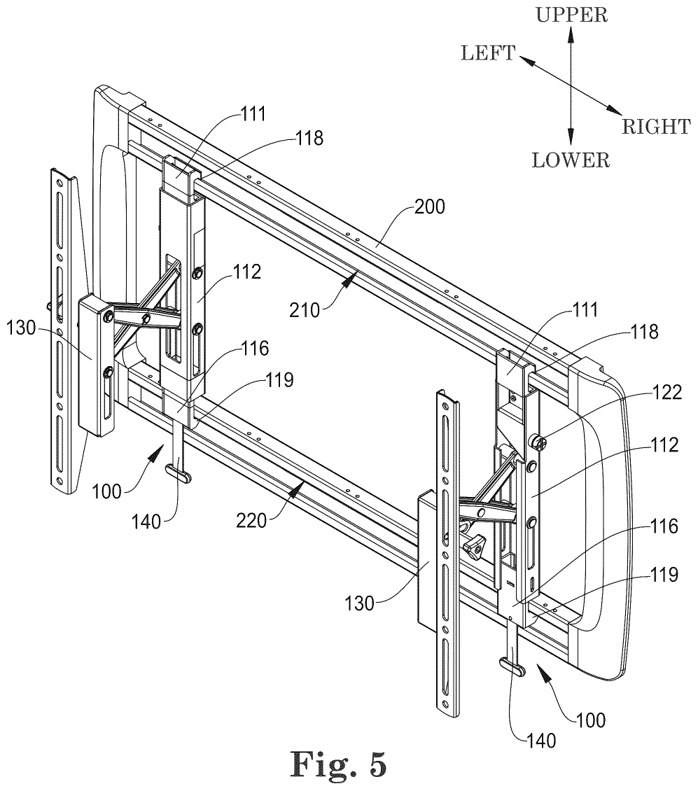

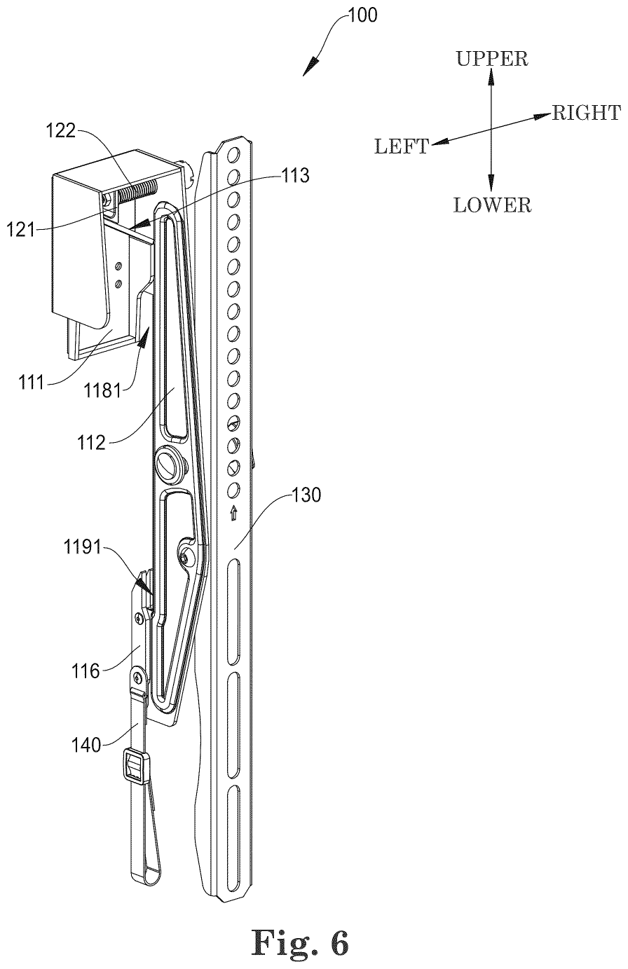

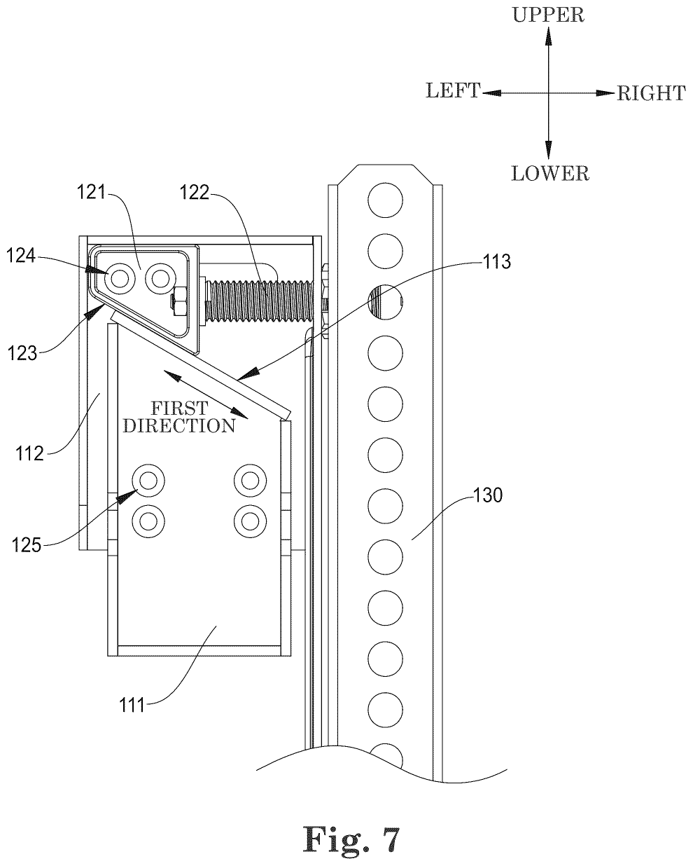

Based on this, with reference to FIGS. 1 to 4 and 6 to 8, the panel-hanging device 100 provided by an embodiment of the first aspect of the present disclosure may include a hanger assembly 110 and an adjustment assembly 120. The hanger assembly 110 is arranged in the vertical direction. The hanger assembly 110 may include a hook assembly 111 and a movable hanger 112. Furthermore, as illustrated in FIG. 1, the hanger assembly 110 can include a second hook assembly 116 and an elastic piece 117 as described in further detail below. Further yet, in some embodiments, the system for mounting a display may include a wall panel 200 and at least one adjustment arm 130 as illustrated and described with respect to FIG. 5. In some examples, an adjustment arm 130 may receive a display bracket with holes or slots to which a display can be mounted. In other examples, an adjustment arm 130 itself may include holes or slots which can receive, for example, bolts, screws and/or nuts to mount a display as shown in FIG. 6.

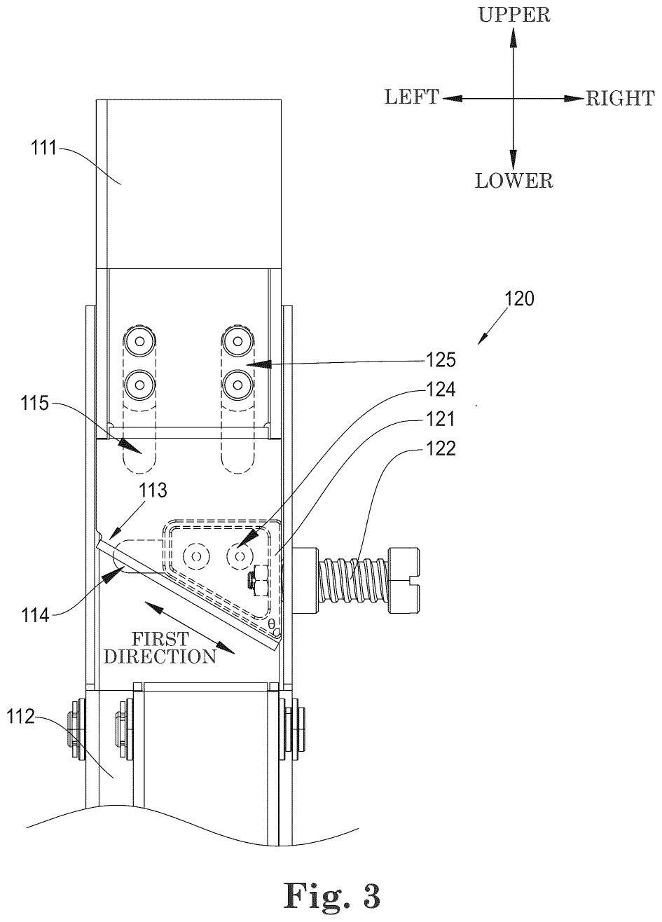

The movable hanger 112 is slidably connected to the hook assembly 111; the adjustment assembly 120 may include one or more interconnected adjustment components 121 and adjustment actuator 122. In some examples of this invention, the extension direction of the adjustment actuator 122 crosses the vertical direction, the one or more adjustment components 121 is connected to the movable hanger 112 (e.g., statically connected, slidably connected, or in engagement with the movable hanger 112 but capable of translating relative to movable hanger 112) and abuts one or more surfaces of the hook assembly 111, the one or more adjustment components 121 has an abutment surface 123 extending in a first direction, and the hook assembly 111 has a support surface 113 extending in the first direction (e.g., abutment surface 123 and support surface 133 are planar, inclined planes that are parallel to one another and slidably or frictionally engage one another). Moreover, in some example embodiments of this disclosure, the adjustment actuator 122 is capable of driving the one or more adjustment components 121 to move relative to the movable hanger 112. For example, adjustment component may be driven in a horizontal direction by an actuator (for example and without limitation, a screw) relative to moveable hanger 112. As the one or more adjustment components 121 makes contact with or abuts a surface of the hook assembly 111, the one or more adjustment components 121 moves in the first direction relative to the hook assembly 111 under the guiding force of the support surface 113, allowing the movable hanger 112 to move in the vertical direction relative to the hook assembly 111. In certain embodiments, the adjustment assembly 120 further includes a first stop 124 and a second stop 125, which are illustrated and described in further detail in FIG. 3. The first direction extends along an interface between the support surface 113 and an abutment surface 123 of the hook assembly 111.

In certain embodiments, the adjustment actuator 122 can include a fastener for insertion into an aperture of the one or more adjustment components 121 to translate the one or more adjustment components along a first direction or a horizontal direction. In certain examples, the adjustment actuator 122 can include a threaded fastener or a bolt with a nut. Further, in some examples, the adjustment actuator 122 may be a screw with portions having different diameters, such as a portion proximal to the head of the screw having a larger circumference with threading, and a potion distal to the head having a narrower circumference with threading. Moreover, in some examples, the adjustment actuator 122 may be secured to the adjustment component 121 by extending a narrower circumference of a screw through an aperture in the adjustment component and securing the narrower portion of the screw to the adjustment component with a nut. In some such examples, the portion of the adjustment actuator having a larger circumference may be received by a threaded nut secured to the exterior of a side wall of movable hanger 112, extending through an aperture in the side wall of movable hanger 112.

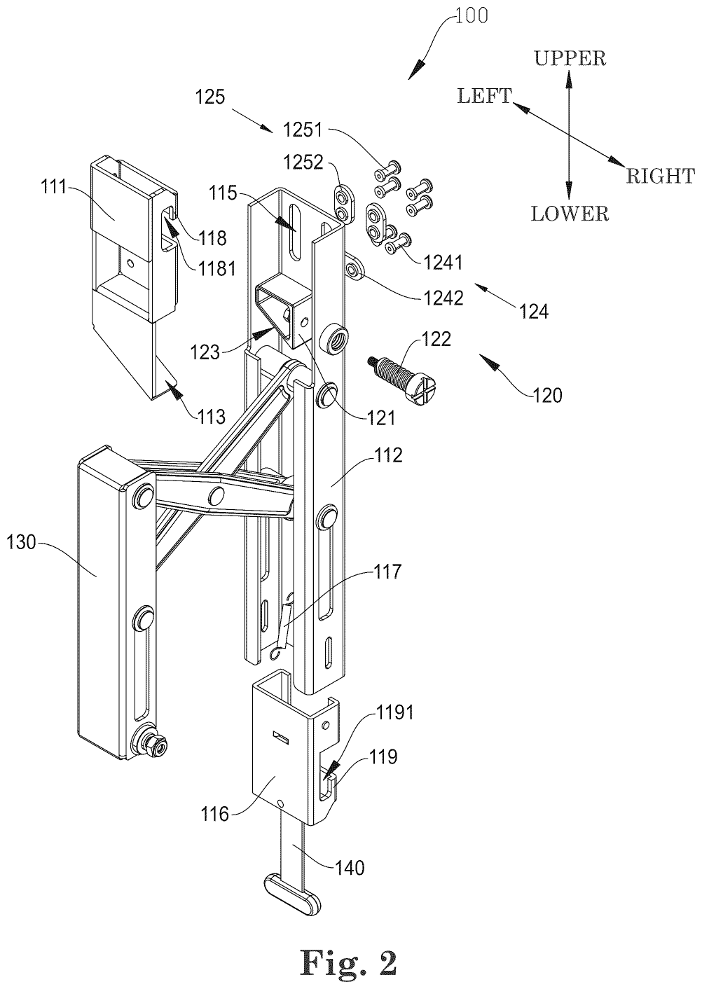

In some example panel-hanging devices, the adjustment component may be shaped as a trapezoid in its vertical cross section, as shown at FIG. 2, movable hanger 112 may be C-shaped in its lateral cross-section, and include one or more lips extending along its length such that a cavity is formed within movable hanger 112 to receive additional components of the panel-hanging device.

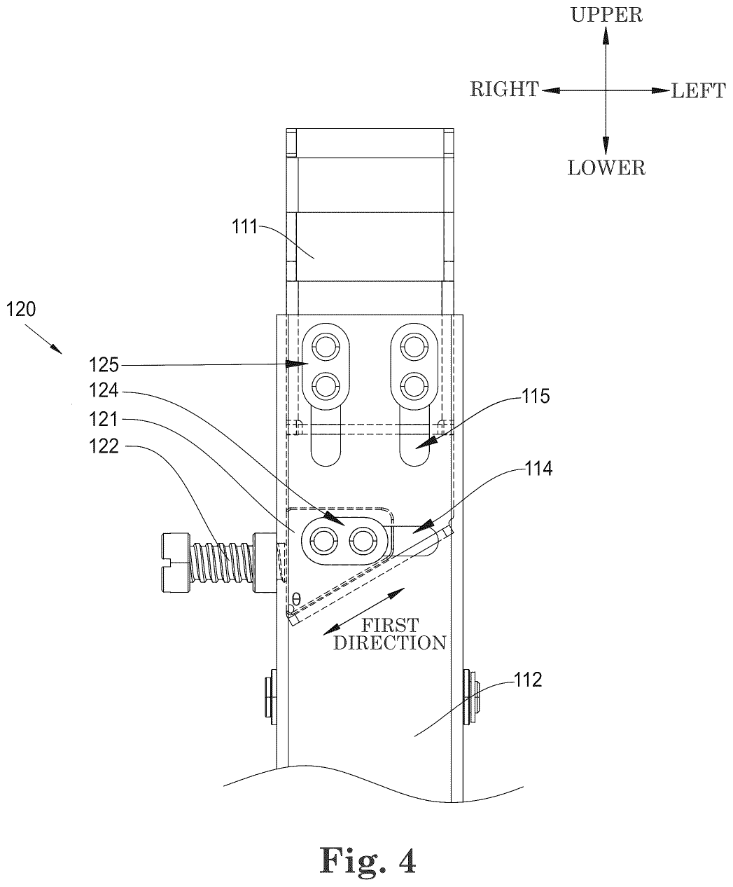

Furthermore, in certain embodiments, and as shown in FIGS. 3-4, the adjustment actuator 122 includes cylindrical body having a varying diameter at a first end of the adjustment actuator 122 and a second end of the adjustment actuator. In certain embodiments the cylindrical body includes a first section having a first diameter and a second section having a second diameter, wherein the first section is larger than an aperture diameter of an aperture in the one or more adjustment components 121 and the second diameter is less than the aperture diameter such that the second section may be inserted through the aperture and the first section cannot be inserted through the aperture. In certain examples, the adjustment actuator 122 is a threaded fastener that is held in place by a threaded nut that screws around the second section and abuts an inner wall of the hook assembly 111.

Still further yet, the one or more adjustment components 121 may include a variety of shapes that are configured to abut the support surface 113 of the hook assembly 111 with an abutment surface 123. In certain non-limiting examples, these shapes may include a trapezoid, a triangle, or any shape having an abutment surface 123 that abuts the support surface 113 in the first direction.

In actual use, the panel-hanging device 100 provided by the example of the first aspect of the present disclosure is mounted on a wall panel 200 having a first hook ledge 210, and the hook assembly 111 is connected to the first hook ledge 210 so that the hook assembly 111 remains relatively stationary with the first hook ledge 210 (or the wall panel 200) during use of the panel-hanging device 100. The specific structural form of the hanger assembly 110 and the adjustment assembly 120 is not limited, and accordingly, the form of mounting between the hanger assembly 110 and the wall panel 200 may also be adaptively set.

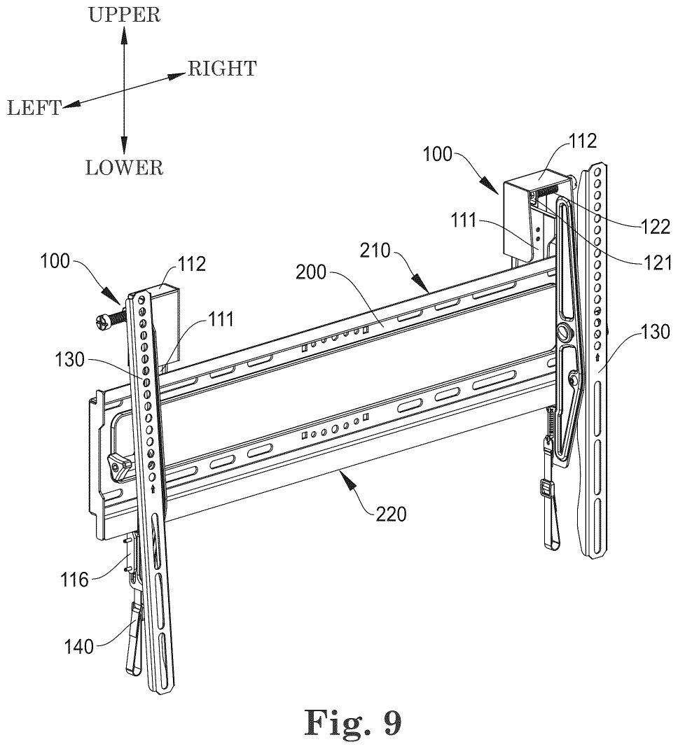

In certain embodiments, with reference to FIGS. 1 to 4, the upper end of the hook assembly 111 is provided with an upper hook 118. The upper hook 118 has an upper snap slot 1181 and the lower side of the upper hook 118 is provided with a support surface 113. With reference to FIG. 5, the upper hook 118 is hung on the first hook ledge 210 of the wall panel 200, allowing the first hook ledge 210 to be housed in the upper snap slot 1181. The one or more adjustment components 121 is located above the support surface 113 and abuts the support surface 113 through the abutment surface 123; in other examples, with reference to FIG. 6, an upper snap slot 1181 is defined between the hook assembly 111 and the movable hanger 112. With reference to FIG. 9, the lower end of the hook assembly 111 is connected with or abuts the wall panel 200, the first hook ledge 210 is housed in the upper snap slot 1181, the hook assembly 111 is provided with a support surface 113 above its low end, and the one or more adjustment components 121 is located above the support surface 113 and abuts the support surface 113 through the abutment surface 123. Of course, it can be understood that in the example of FIG. 9, after the lower end of the hook assembly 111 abuts the first hook ledge 210, it can also be fixed by welding, screw locking, etc. to keep the hook assembly 111 and the first hook ledge 210 (or the wall panel 200) relatively stationary.

In the panel-hanging device 100 provided by the example of the first aspect of the present disclosure, the one or more adjustment components 121 is slidably connected to the movable hanger 112 and abuts the hook assembly 111, and the one or more adjustment components 121 has an abutment surface 121 extending in the first direction and/or the hook assembly 111 has a support surface 113 extending in the first direction. The extension direction of the adjustment actuator 122 crosses the vertical direction; that is, the adjustment actuator 122 can extend towards or from the side of the television. When the height needs to be adjusted, the user's hand can operate the adjustment actuator 122 from the side of the television, the adjustment actuator 122 drives the one or more adjustment components 121, and the abutment surface 123 extending in the first direction and/or the support surface 113 extending in the first direction can convert the movement of the one or more adjustment components 121 in the extension direction of the adjustment actuator 122 into the movement of the movable hanger 112 in the vertical direction, making operation more convenient.

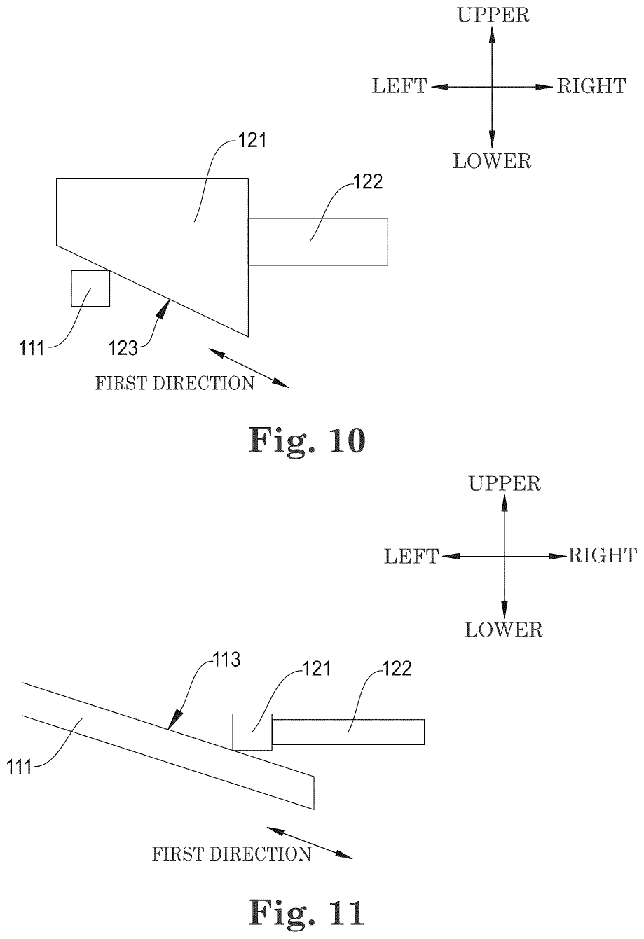

The form of abutment between the one or more adjustment components 121 and the hook assembly 111 is not limited to the scheme shown in FIGS. 1 to 9. With reference to FIG. 10, only the at least one adjustment component 121 has an abutment surface 123 extending in the first direction. When the adjustment actuator 122 moves the one or more adjustment components 121, the abutment surface 123 of the one or more adjustment components 121 is connected to the hook assembly 111 and moves in the first direction relative to the hook assembly 111, and the movable hanger 112 connected to the one or more adjustment components 121 thereby moves up and down relative to the hook assembly 111; or, with reference to FIG. 11, it is also possible that only the hook assembly 111 has a support surface 113 extending in the first direction. When the adjustment actuator 122 moves the one or more adjustment components 121, the one or more adjustment components 121 abuts the support surface 113 of the hook assembly 111 and moves in the first direction relative to the hook assembly 11, and the movable hanger 112 connected to the one or more adjustment components 121 thereby moves up and down relative to the hook assembly 111.

Further, with reference to FIGS. 1 to 4 and 6 to 8, the adjustment actuator 122 is threadedly connected to the movable hanger 112, and the one or more adjustment components 121 can be moved by rotating or twisting the adjustment actuator 122. The operation is relatively simple, and the adjusted adjustment actuator 122 and the movable hanger 112 can be relatively fixed without other fixation structures. Structural stability is relatively high in such an arrangement; in addition, the distance that the adjustment actuator 122 moves in the extension direction of the adjustment actuator 122 is fixed when it is rotated one turn. The rotating of the adjustment actuator 122 can raise and lower the movable hanger 112 at a relatively stable speed, making operation simpler.

It can be understood that a standard bolt piece can be selected for the adjustment actuator 122. The larger the thread pitch, the greater the distance moved in the extension direction of the adjustment actuator 122 when rotated one turn. The selection can be made according to actual needs.

Further, with reference to FIGS. 3, 4, 7, and 8, the one or more adjustment components 121 has an abutment surface 123 extending in the first direction, the hook assembly 111 has a support surface 113 extending in the first direction, the support surface 113 conforms to the abutment surface 123, thereby making the abutment between the one or more adjustment components 121 and the hook assembly 111 more stable, and the movement of the one or more adjustment components 121 can be more stably directed by the support surface 113 and the abutment surface 123 that conform to each other and both extend in the first direction, which is conducive to improving the structural stability of the panel-hanging device 100.

Further, a wear-reducing piece or wear-reducing layer may be provided between the support surface 113 and the abutment surface 123 to reduce the friction between the support surface 113 and the abutment surface 123, so as to reduce the force of the adjustment operation. In some examples, a wear-reducing piece such as a wear-reducing pad or ball may be provided between the support surface 113 and the abutment surface 123. The wear-reducing piece may be connected to the support surface 113 or the abutment surface 123. Further, the position of the wear-reducing piece should ensure that no matter where the one or more adjustment components 121 is moved relative to the hook assembly 111, the support surface 113 and the abutment surface 123 are always separated by the wear-reducing piece. For example, the wear-reducing piece may be provided to the entire support surface 113 to ensure that the one or more adjustment components 121 is always subjected to only a small frictional force during movement; in some other examples, lubricant or grease may be applied to the support surface 113 and/or the abutment surface 123 to form a wear-reducing layer.

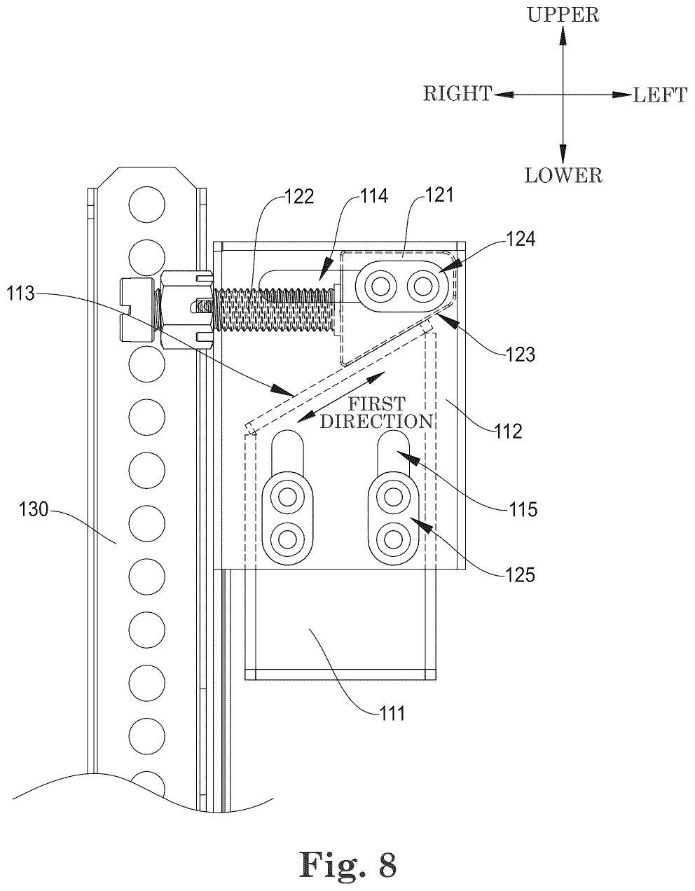

The angle between the first direction and the vertical direction is not limited and can be set according to actual needs. For example, the angle between the first direction and the vertical direction described herein may be an acute angle formed between the two, when measured, e.g., where the first direction of surface 113 intersects a vertical direction of the sidewall of movable hanger 112 through which the adjustment actuator passes, as shown in FIGS. 3 and 8.

In some examples, with reference to FIGS. 3, 4, 7, and 8, the adjustment actuator 122 extends in the horizontal direction, the one or more adjustment components 121 can slide or be translated in the horizontal direction relative to the movable hanger 112, and an angle θ between the first direction and the vertical direction is 45 degrees. The angle θ is shown, for example, in FIGS. 3-4. When the adjustment actuator 122 moves the one or more adjustment components 121 a certain distance in the horizontal direction, the one or more adjustment components 121 can drive the movable hanger 112 to move the same distance in the vertical direction. The user can directly obtain the distance that the movable hanger 112 moves in the vertical direction by observing the distance that the adjustment actuator 122 moves; i.e., by observing the change in length of the adjustment actuator 122 extending before and after adjustment. The resulting height adjustment distance of a display mounted on adjustment arms or display brackets of a panel-hanging display is therefore intuitive to a user.

In some examples, the angle θ of the first direction and the vertical direction may also be set to be greater than 0 degrees and less than 45 degrees, for example, when measured at the intersection of a plane extending along surface 113 and a plane extending along a vertical surface of movable hanger 112 through which the adjustment actuator 122 passes. When the adjustment actuator 122 moves the one or more adjustment components 121 a certain distance in the horizontal direction, the one or more adjustment components 121 can drive the movable hanger 112 to move a greater distance in the vertical direction. Therefore, when the adjustment actuator 122 is able to move a certain distance in the horizontal direction, the movable hanger 112 can move a greater distance in the vertical direction, enabling rapid adjustment of the movable hanger 112 in the vertical direction; and it is also conducive to reducing the width dimension of the movable hanger 112 to make the structure of the panel-hanging device 100 more compact.

In some examples, the angle of the first direction and the vertical direction may also be set to be greater than 45 degrees and less than 90 degrees. In some examples, the angle of the first direction and the vertical direction may also be set to be greater than 0 degrees and less than 90 degrees. When the adjustment actuator 122 moves the one or more adjustment components 121 a certain distance in the horizontal direction, the one or more adjustment components 121 can drive the driven movable hanger 112 to move a smaller distance in the vertical direction, realizing the fine adjustment of the movable hanger 112 in the vertical direction.

Further, with reference to FIGS. 3, 4, 7, and 8, the movable hanger 112 has a first stop slot 114, the one or more adjustment components 121 is provided with a first stop 124, and the first stop 124 is at least partially housed in the first stop slot 114 and can move inside the first stop slot 114. The extension direction of the first stop slot 114 is the same as the extension direction of the adjustment actuator 122, making the structural layout more reasonable. The first stop 124 and the first stop slot 114 that match with each other can guide the movement of the one or more adjustment components 121 so that the one or more adjustment components 121 can only move in the extension direction of the adjustment actuator 122, ensuring the stability of the movement of the movable hanger 112 during adjustment.

It can be understood that the one or more adjustment components 121 can also be provided with a first stop slot 114 and the movable hanger 112 provided with a first stop 124, which can also guide the direction of the movement of the one or more adjustment components 121.

The structural form of the first stop 124 is not limited. It is sufficient to match with the first stop slot 114 to guide the one or more adjustment components 121. For example, with reference to FIG. 2, the first stop 124 includes a first rivet 1241 and a first mounting piece 1242, the one or more adjustment components 121 and the first mounting piece 1242 are arranged on both sides of the movable hanger 112, the first rivet 1241 is arranged on the first stop slot 114 of the movable hanger 112, and both ends are riveted to the one or more adjustment components 121 and the first mounting piece 1242, respectively. The first mounting piece 1242 can abut the side of the movable hanger 112 away from the one or more adjustment components 121 to prevent the one or more adjustment components 121 from being separated from the movable hanger 112.

Further, with reference to FIGS. 3, 4, 7, and 8, the hook assembly 111 has a second stop slot 115, the movable hanger 112 is provided with a second stop 125, the second stop 125 is at least partially housed in the second stop slot 115 and can move inside the second stop slot 115, and the second stop slot 115 extends in the vertical direction. The second stop 125 and second stop slot 115 that match with each other can guide the movement of the movable hanger 112 so that the movable hanger 112 can only move in the vertical direction, ensuring the stability of the movement of the movable hanger 112 during adjustment.

It can be understood that the movable hanger 112 can also be set to have a second stop slot 115 and the hook assembly 111 set to have a second stop 125, which can also guide the direction of the movement of the movable hanger 112.

The structural form of the second stop 125 is not limited. It is sufficient to match with the second stop slot 115 to guide the movable hanger 112. For example, with reference to FIG. 2, the second stop 124 includes a second rivet 1251 and a second mounting piece 1252, the movable hanger 112 and the second mounting piece 1252 are provided on both sides of the hook assembly 111, the second rivet 1251 is provided on the second stop slot 115 of the hook assembly 111, and both ends are riveted to the movable hanger 112 and the second mounting piece 1252, respectively. The second mounting piece 1252 can abut the hook assembly 111 away from the side of the movable hanger 112 to prevent the movable hanger 112 from separating from the hook assembly 111.

Further, with reference to FIGS. 5 and 9, the wall panel 200 also may include a second hook ledge 220 located below the first hook ledge 210, and with reference to FIGS. 1, 2, and 6, the hanger assembly 110 may further include a second hook assembly 116, which is movably connected to the movable hanger 112. The form of the mounting between the hanger assembly 110 and the wall panel 200 can be adaptively set. In some examples, with reference to FIGS. 1 and 2, the second hook assembly 116 can be set with a lower hook 119, which has a lower snap slot 1191. With reference to FIG. 5, the lower hook 119 is snap-connected to the second hook ledge 220 so that the second hook ledge 220 is housed in the lower snap slot 1191; in other examples, the second hook assembly 116 and the movable hanger 112 are defined with a lower snap slot 1191. With reference to FIG. 9, the second hook assembly 116 and the partially movable hanger 112 are respectively located on both sides of the second hook ledge 220 and the second hook ledge 220 is housed in the lower snap slot 1191. When the panel-hanging device 100 needs to be mounted on the wall panel 200, the second hook assembly 116 can be adjusted first to a position that does not hinder the mounting of the panel-hanging device 100. The hook assembly 111 is first snap-connected onto the first hook ledge 210 and then the second hook assembly 116 is adjusted snap-connect to the second hook ledge 220 so that the panel-hanging device 100 can snap-connect onto the wall plate 200 without falling off easily. The second hook assembly 116, which is movably connected to the movable hanger 112, facilitates mounting of the panel-hanging device 100, which is conducive to the ease of use of the panel-hanging device 100.

It can be understood that the method of movable connection between the second hook assembly 116 and the movable hanger 112 is not limited and can be set as a sliding connection, a rotating connection, a removable connection, etc.

Further, with reference to FIGS. 1 and 2, the hanger assembly 110 also may include an elastic piece 117. Both ends of the elastic piece 117 are respectively connected to the movable hanger 112 and the second hook assembly 116 and the second hook assembly 116 can be snap-connected to the second hook ledge 220 under the elastic force of the elastic piece 117. When the adjustment assembly 120 is operated to adjust the height of the movable hanger 112, the position of the second hook assembly 116 relative to the wall panel 200 remains unchanged and it is always able to clamp the wall panel 200 so that the panel-hanging device 100 can be securely fixed to the wall panel 200 to improve structural stability.

Further, with reference to FIGS. 1 to 9, the panel-hanging device 100 may further include a drawstring 140, the second hook assembly 116 being slidably connected to the movable hanger 112, and the drawstring 140 being connected to the second hook assembly 116. Pulling the drawstring 140 may disengage the second hook assembly 116 from the second hook ledge 220 in order to mount or remove the television.

Further, with reference to FIGS. 1 to 9, the panel-hanging device 100 may further include an adjustment arm 130 connected to the movable hanger 112, the adjustment arm 130 being used to mount on the television, and the adjustment arm 130 may adopt a structure capable of achieving functions such as telescoping and angular adjustment of the television to meet different usage needs.

With reference to FIGS. 5 and 9, the television mount provided by the example of the second aspect of the present disclosure is used to mount the television to a wall. The television mount includes a wall panel 200 and a panel-hanging device 100 provided by any of the examples of the first aspect of the present disclosure. The wall panel 200 has a first hook ledge 210 and the wall panel 200 is used for mounting on the wall; the hook assembly 111 is connected to the first hook ledge 210 so that the hook assembly 111 and the first hook ledge 210 (or the wall panel 200) remain relatively stationary during use of the panel-hanging device 100, and the movable hanger 112 is used to mount the television. After the wall panel 200 is mounted on the wall, if there is a certain error in the levelness of the wall panel 200, after the panel-hanging device 100 is snap-connected onto the wall panel 200, the user's hand can operate the adjustment actuator 122 from the side of the television. The adjustment actuator 122 drives the one or more adjustment components 121 to move, and the abutment surface 123 extending in the first direction and/or the support surface 113 extending in the first direction can convert the movement of the adjustment piece 121 in the first direction into the movement of the movable hanger 112 in the vertical direction to adjust the levelness of the display, making operation more convenient.

Further, with reference to FIGS. 5 and 9, two panel-hanging devices 100 are provided, and the two panel-hanging devices 100 are respectively used to mount on both sides of the television in the horizontal direction so that the height of both sides of the display or television in the horizontal direction can be adjusted by the adjustment piece 120 in the corresponding panel-hanging device 100 to increase the convenience of the adjustment of the levelness of the television.

The terminology used herein to describe the previous and following embodiments and Figures are not intended to be limited to those embodiments. For example and without limitation, the terms “adjustment component” may sometimes be used interchangeably with “lifting part,” or display bracket or “installation part” or “adjustment arm” may sometimes be used interchangeably, and these terms may be used to describe the different embodiments as shown in the following Figures of the present disclosure.

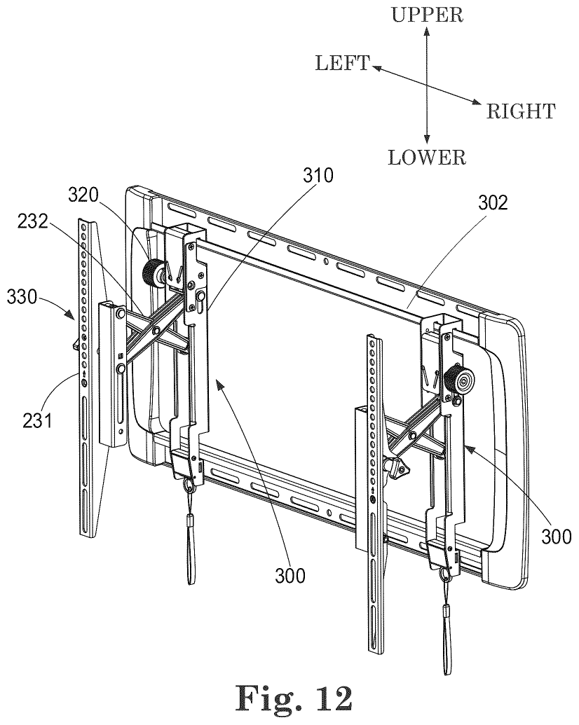

FIG. 12 shows an exemplary display or television hanging rack of the example of the present disclosure, including a suspension device 300 and a wall panel 302. The wall panel 302 is used to be fixed on the wall, and the suspension device 300 is connected to the wall panel 302. The suspension device 300 is used to hang the television.

It can be understood that the suspension device 300 can also be used to hang a computer display screen or other display devices.

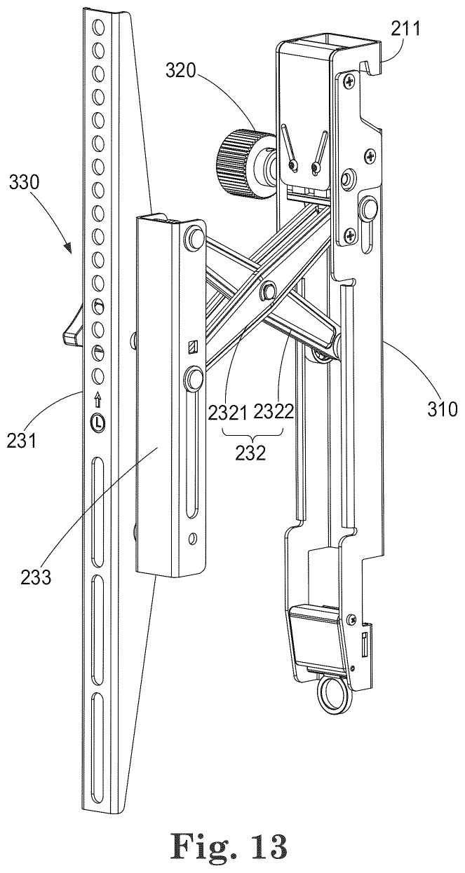

As shown in FIGS. 12 and 13, the suspension device 300 includes a hanging arm component 310, an adjustment component 320 and an installation component 330. The hanging arm component 310 is used to hang on the wall panel 302.

Specifically, a hook 211 is configured on the top of the hanging arm component 310, and the hook 211 is hung on the wall panel 302, such that the suspension device 300 and the wall panel 302 are connected together.

It can be understood that after the hanging arm component 310 is hung on the wall panel 302, it can move left and right along the wall panel 302, thereby facilitating the installation of displays or televisions of different sizes.

As shown in FIG. 13, an adjustment component 320 is positioned on the hanging arm component 310, and the adjustment component 320 may be used to adjust the height of the installation component 330, and any display attached thereto.

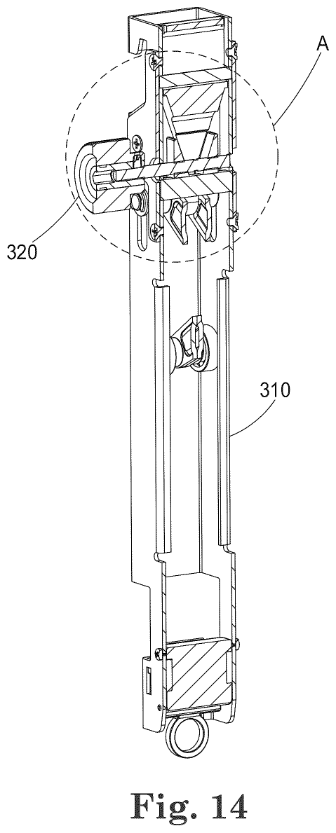

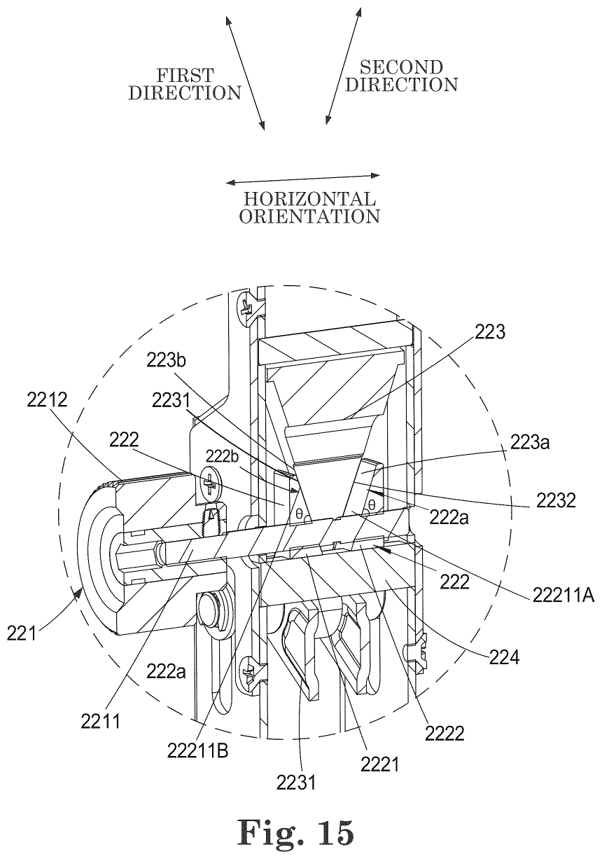

Specifically, with reference to FIGS. 14 and 15, the adjustment component 320 includes an adjustment actuator 221, a lifting part 222 and a vertical adjustment component 223. The adjustment actuator 221 (e.g., a knob) may be positioned on the hanging arm component 310 and may be driven (e.g., rotated), in engagement with the lifting part 222. When driven, the lifting part 222 in turn engages and drives translation of the vertical adjustment component 223 (for example, two triangular elements of lifting part 222 may contact each side, respectively, of the vertical adjustment component and raise or lower the vertical adjustment component.

It can be understood that the adjustment actuator 221 is positioned on the hanging arm component 310, such that the lifting part 222 and the vertical adjustment component 223 are directly or indirectly connected on the hanging arm component 310. The adjustment actuator 221 can drive the action of the lifting part 222, such that the lifting part 222 drives the vertical adjustment component 223.

As shown in FIG. 15, in some examples, the lifting part 222 has a guide wall, the vertical adjustment component 223 also has a guide wall, the guide wall of the lifting part 222 being configured to engage and align with (e.g., extend in planes parallel to one another) the guide wall of the vertical adjustment component 223. Furthermore, the extension direction of the guide wall intersects with the vertical direction and is not itself vertical. The vertical adjustment component 223 can be driven by the adjustment actuator 221 to move vertically by virtue of engagement with elements of the lifting part 222, such that the vertical adjustment component 223 moves in the vertical direction relative to the hanging arm component 310.

For example, a guide wall on the lifting part 222 may include a first guide wall 222a, and a guide wall on the vertical adjustment component 223 may include a second guide wall 223a configured to engage first guide wall 222a. In such examples, the extension direction or plane of the first guide wall 222a is parallel to the extension direction or plane of the second guide wall 223a, and the extension direction or plane of the first guide wall 222a and the extension direction of the second guide wall 223a intersect in the vertical direction or plane and are not perpendicular to the vertical direction or plane. In addition, the first guide wall 222a and the second guide wall 223a engage each other and are guide-coordinated.

It can be understood that the adjustment actuator 221 can controllably drive the lifting part 222, such that the vertical adjustment component 223 simultaneously moves with the lifting part 222 by virtue of engagement along the extension direction or plane of the first guide wall 222a and second guide wall 223a, resulting in vertical translation of vertical adjustment component 223 relative to lifting part 222.

Moreover, when the hanging arm component 310 is used as a reference, when the elements of lifting part 222 are driven by the adjustment actuator 221 such that lifting part 222 translates horizontally and moves relative to the hanging arm component 310, the lifting part 222 drives the vertical adjustment component 223 to move in the vertical direction.

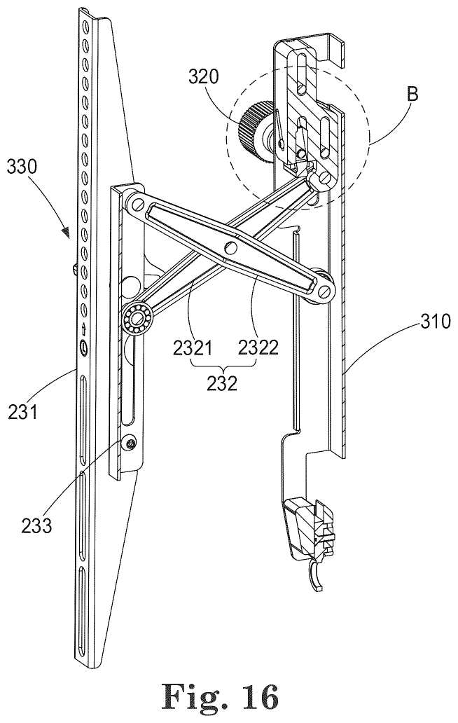

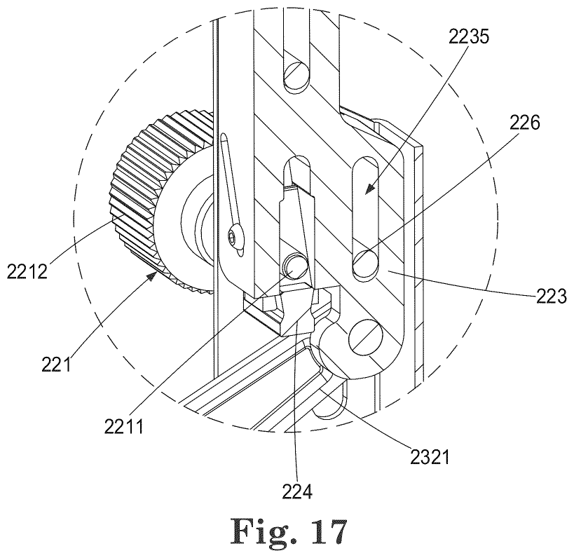

In reference to FIG. 16 and FIG. 17, a display bracket or installation component 330 may be utilized to mount a display or television, and the installation component 330 is driven and moves in conjunction with and in parallel with the vertical adjustment component 223, by virtue of its indirect engagement to vertical adjustment 223. For example, as shown FIGS. 16 and 17, installation component (and any display mounted thereon) may be connected to vertical adjustment component 223 via a connection unit 232. For example and without limitation, connection unit 232 may include movable and collapsible arms, such as a first connection part 2321 and a second connection part 2322.

Specifically, a display or television may be connected to the installation component 330 using screws, bolts, and nuts, or the like. When the vertical adjustment component 223 rises and lowers, the installation component 330 likewise is driven to rise or lower, thereby adjusting the vertical level of the television.

As shown in FIG. 12, it should be noted that the television hanging rack has two suspension devices 300, and the two suspension devices 300 optionally may be arranged on the wall panel 302 with one on the left and one on the right, and the hanging arm component 310 of each suspension device 300 is hung on wall panel 302. The two suspension devices 300 are used to connect the left and right sides of a television, respectively. After adjusting the height of the vertical adjustment component 223 in one or both suspension devices 300, the level of the television can be adjusted accordingly.

Of course, in other examples, as long as one of the suspension devices 300 is the suspension device 300 described above, the horizontality of the television can also be adjusted on one side and not the other.

As shown in FIGS. 12 to 17, when the suspension device 300 of the present disclosure is in use, the hanging arm component 310 is hung on the wall panel 302, and the installation component 330 is used to connect to the display; after the display is installed on the installation component 330, if uneven tilting of the display occurs, the adjustment actuator 221 can be controlled (for example, a knob that turns and drives components, as further described herein) such that the adjustment actuator 221 drives the lifting part 222, and in turn the vertical adjustment component 223 moves relative to the lifting part 222 by virtue of engagement along the extension direction of the guide wall (including for example, engagement of two separate elements of lifting part 222 along a first direction and second direction, as shown in FIG. 15), such that the vertical adjustment component 223 moves relative to the hanging arm component 310 in the vertical direction. In such a circumstance, the vertical adjustment component 223 translates in parallel with the installation component 330 in the vertical direction relative to the hanging arm component 310, due to their connection, thereby adjusting the level of the display.

While the mount shown in FIG. 12 includes a vertical adjustment component 223 on two hanging arm components 310, this disclosure further contemplates that in mounting systems where there are two hanging arm components that can be hung on a wall panel 302, optionally, only one of the two hanging arm components 310 need include an adjustment component 320, such that any unevenness in a display mounted on a display bracket or installation part 330 can be adjusted vertically from the side of only one of two hanging arm components.

Further, as shown in FIG. 15, the lifting part 222 includes a first lifting part 2221 and a second lifting part 2222 spaced apart from the first lifting part 2221 in the horizontal direction. In such an example, actuation of the adjustment actuator 221 (e.g., rotation thereof) may be used to drive the first lifting part 2221 and the second lifting part 2222 towards or away from each other in horizontal translation. Further, in such an example, at least part of the vertical adjustment component 223 is arranged between the first lifting part 2221 and the second lifting part 2222, such that when the first and second lifting parts move toward each other, they impart force on the vertical adjustment component causing it to rise vertically, and when the first and second lifting parts move away from each other, the vertical adjustment component lowers vertically into the space between the lifting parts.

It can be understood that at least part of the vertical adjustment component 223 is configured between the first lifting part 2221 and the second lifting part 2222, and can be limited under the action of the first lifting part 2221 and the second lifting part 2222, and, by configuring the first lifting part 2221 and second lifting part 2222, such that when the vertical adjustment component 223 moves in the vertical direction, it is acted upon by the first lifting part 2221 and the second lifting part 2222 at the same time, and the force is more uniform and balanced. In this way, the vertical adjustment component 223 can be ensured stability and reliability when lifting and moving.

In some examples, both the first lifting part 2221 and the second lifting part 2222 have guide walls. The guide wall of the first lifting part 2221 may include a first guide wall 22211A, and the guide wall of the second lifting part 2222 may include a first guide wall 22211B; wherein, the first guide wall 22211A is located on the side of the first lifting part 2221 close to the second lifting part 2222. The first guide wall 22211B is located on the side of the second lifting part 2222 close to the first lifting part 2221.

It can be understood that the first guide wall 22211A and the first guide wall 22211B are spaced apart and relatively arranged along the horizontal direction, and under the action of the adjustment actuator 221, when the first lifting part 2221 and the second lifting part 2222 are close to (or away from) each other, the first guide wall 22211A and first guide wall 22211B are also close to (or away from) each other.

Further, in some examples, first guide wall 22211A gradually tilts away from first guide wall 22211B from bottom to top, the first guide wall 22211B gradually tilts away from first guide wall 22211A from bottom to top, and the distance between first guide wall 22211A and first guide wall 22211B gradually becomes larger from the bottom to the top.

It can be understood that in some examples, the first guide wall 22211A and the first guide wall 22211B are both tilted, and the direction of the tilt of the first guide wall 22211A is different from the direction of the tilt of the first guide wall 22211B.

Specifically, as shown in FIG. 15, the first guide wall 22211A and the first guide wall 22211B may be configured symmetrically along a vertical plane, the first guide wall 22211A extends along the first direction, the first guide wall 22211B extends along the second direction, both the first direction and the second direction are set at angles with the vertical direction, and neither the first direction nor the second direction is perpendicular to the vertical direction.

In some examples, the first guide wall 22211A and the first guide wall 22211B both have planar structures; in other examples, first guide wall 22211A and first guide wall 22211B can also both have arc structures.

Among them, the first guide wall 22211A and the first guide wall 22211B both support the vertical adjustment component 223.

It should be noted that the vertical adjustment component 223 directly or indirectly resists the first guide wall 22211A and/or the first guide wall 22211B. The first guide wall 22211A and the first guide wall 22211B both support vertical adjustment component 223, and the vertical adjustment component 223 can move along the first guide wall 22211A and the first guide wall 22211B.

It can be understood that when the adjustment actuator 221 drives the first lifting part 2221 and the second lifting part 2222 to approach each other, under the action of the first guide wall 22211A and the first guide wall 22211B, the vertical adjustment component 223 are both relative to the first lifting part 2221 moves upward due to engagement along the extension direction of the first guide wall 22211A, and moves upward due to engagement along the extension direction of the first guide wall 22211B relative to second lifting part 2222, thereby rising relative to the hanging arm component 310; when the adjustment actuator 221 drives the first lifting part 2221 and the second lifting part 2222 away from each other, under the action of gravity, the vertical adjustment component 223 moves downward relative to first lifting part 2221 and moves downward relative to second lifting part 2222, such that it lowers relative to the hanging arm component 310.

In certain embodiments, the adjustment actuator 221, the first lifting part 2221, and the second lifting part 2222 are threaded, and the rotation of the adjustment actuator 221 drives the movement of the first lifting part 2221 and the second lifting part 2222 along a horizontal axis. In certain examples, the first lifting part 2221 and the second lifting part 2222 are threaded in opposite directions such that the turning of the adjustment actuator 221 in a clockwise or counter-clockwise direction will cause the first lifting part 2221 and the second lifting part 2222 to move relative to one another such that a space between the first lifting part 2221 and the second lifting part 2222 increases or decreases. When the space decreases, the first guide wall 22211A and the second guide wall 22211B abut the vertical adjustment component 223 to frictionally engage the vertical adjustment component 223 along the first direction and cause the vertical adjustment component 223 to be lifted upward in a vertical direction. When the space decreases, the vertical adjustment component 223 remains frictionally engaged with the first guide wall 22211A and the second guide wall 22211B while being lowered downward in the vertical direction.

It should be noted that the vertical adjustment component 223 is configured to only move along the height direction of the hanging arm component 310. In this way, when the adjustment actuator 221 drives the first lifting part 2221 and the second lifting part 2222 to move closer to or farther away from each other, the vertical adjustment component 223 can be ensured stability and reliability during the lifting and lowering process.

Specifically, the vertical adjustment component 223 is arranged inside the hanging arm component 310. The inner wall of the hanging arm component 310 plays a guiding role for the vertical adjustment component 223, which is used to guide the vertical adjustment component 223 to move along the height direction of the hanging arm component 310 and limit the vertical adjustment component 223 from moving in the horizontal direction.

As shown in FIG. 15, further, the second guide wall 223B on the vertical adjustment component 223 includes a second guide wall 2231 and a second guide wall 2232B arranged on the opposite side. The second guide wall 2231 gradually tilts away from the second guide wall 2232B from bottom to top. The second guide wall 2232B gradually tilts away from the second guide wall 2231 from bottom to top, and the distance between the second guide wall 2231 and the second guide wall 2232B gradually becomes larger from the bottom to the top.

It can be understood that both the second guide wall 2231 and the second guide wall 2232B are arranged in a tilted configuration, and the direction of the tilt of the second guide wall 2231 is different from the direction of the tilt of the second guide wall 2232B.

Specifically, the second guide wall 2231 and the second guide wall 2232B are symmetrically arranged along a vertical plane, the second guide wall 2231 extends along the first direction, the second guide wall 2232B extends along the second direction. The shape of the second guide wall 2231 and the first guide wall 22211A have the same shape. The second guide wall 2232B and the first guide wall 22211B have the same shape.

Among them, the second guide wall 2231 cooperates with the first guide wall 22211A, and the second guide wall 2232B cooperates with the first guide wall 22211B.

It can be understood that the second guide wall 2231 and the second guide wall 2232B directly or indirectly resist the first guide wall 22211A and the first guide wall 22211B, and the second guide wall 2231 and the second guide wall 2232B can respectively move along the first guide wall 22211A and the first guide wall 22211B. In addition, it can cause the first lifting part 2221 and the second lifting part 2222 to have a larger contact area with the vertical adjustment component 223, which can improve the stability of the vertical adjustment component 223 during the lifting and lowering process.

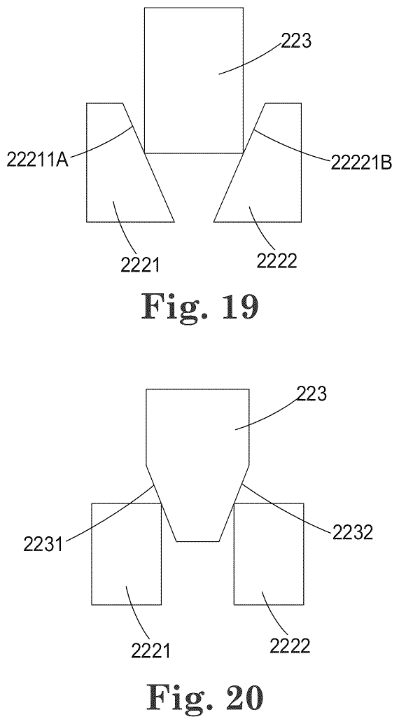

It should be noted that in some other examples, as shown in FIG. 19, the vertical adjustment component 223 does not need to be configured on the second guide wall 2231A and the second guide wall 2232B, and only configures the first guide wall 22211A on the first lifting part 2221. The first guide wall 22211B is configured on the second lifting part 2222, and the vertical adjustment component 223 can also be raised and lowered when the first lifting part 2221 and the second lifting part 2222 are close to or far away from each other.

Of course, in other examples, as shown in FIG. 20, the first guide wall 22211A does not need to be configured on the first lifting part 2221, the first guide wall 22211B does not need to be configured on the second lifting part 2222, and the second guide wall 2231 and the second guide wall 2232B only need to be configured on the vertical adjustment component 223, which can also make the first lifting part 2221 and the second lifting part 2222 to move closer to or farther away from each other, such that the vertical adjustment component 223 can be raised or lowered.

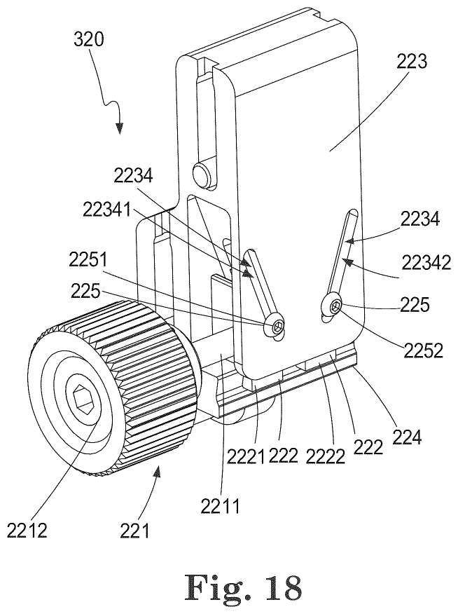

Combining FIG. 15 and FIG. 18, in some examples, the adjustment component 320 further includes a guide 224 configured on the hanging arm component 310 and extending in the horizontal direction, and the first lifting part 2221 and the second lifting part 2222 are both configured on the guide 224.

Specifically, the guide 224 is fixedly configured on the hanging arm component 310, and the guiding direction of the guide 224 is the same as the horizontal direction. The guide 224 is used to guide the first lifting part 2221 and the second lifting part 2222 to move in the horizontal direction, thereby improving the movement accuracy of the first lifting part 2221 and the second lifting part 2222. In addition, the guide 224 can also limit the freedom of movement or rotation of the first lifting part 2221 and the second lifting part 2222 in other directions to ensure the accurate operation of the adjustment component 320.

As shown in FIG. 15, further, the adjustment actuator 221 is configured between the first lifting part 2221 and the second lifting part 2222, and the adjustment actuator 221 is configured to be able to rotate around its central axis to drive the first lifting part 2221 and the second lifting part 2222 to move closer to or farther away from each other. In this way, the first lifting part 2221 and the second lifting part 2222 can be controlled to move simultaneously by rotating the adjustment actuator 221, and the control method is simple.

Specifically, the adjustment actuator 221 may include an adjusting rod 2211. The adjusting rod 2211 includes a first thread section and a second thread section. The thread rotation direction of the first thread section is opposite to the thread rotation direction of the second thread section. The first lifting part 2221 is configured with a thread for the first thread section to engage and pass through. The second lifting part 2222 is configured with a first threaded hole designed and aligned with the thread of the first thread section. The second lifting part 2222 is configured with a second threaded hole designed and aligned with the second thread section. Therefore, when adjustment actuator 221 is rotated, the threaded adjusting rod 2211 drives the first lifting part 2221 and the second lifting parts 2222 to move closer to or farther away from each other.

It can be understood that under the action of the guide 224, the first lifting part 2221 and the second lifting part 2222 can only move in the horizontal direction. In this way, the first lifting part 2221 and the second lifting part 2222 can be prevented from rotating with the adjusting rod 2211.

Further, the adjustment actuator 221 also includes a connection knob 2212 at the end of the adjusting rod 2211. The connection knob 2212 is located on the side of the suspension device 300 away from the center of the television. In this way, the user can conveniently grasp the connection knob 2212 from the side edge area of the television and rotate the connection knob 2212 to drive the adjusting rod 2211 to rotate in either direction, and cause a display to be vertically adjusted.

It should be noted that in some examples, the adjusting rod 2211 extends in the horizontal direction, and the adjusting rod 2211 can extend from the side of the hanging arm component 310. In this way, when the level of the television needs to be adjusted, a user's hands can reach toward the sides of the television and behind the television to operate the connection knob 2212 to adjust the height of the vertical adjustment component 223, which is easy to operate.

It can be understood that the extension direction of the adjusting rod 2211 can also be configured at an acute angle with the horizontal direction. Similarly, the adjustment rod can also be extended from the side of the hanging arm component 310 to facilitate user adjustment.

As shown in FIG. 15 and FIG. 18, in some examples, an exterior surface of the vertical adjustment component 223 is configured with one or more guide troughs 2234, and the extension direction of the one or more guide troughs 2234 is parallel to the extension direction of one or more guide walls; the adjustment component 320 also may include first and second lifting parts 222 that are movably installed on respective guide troughs 2234 via respective limit shafts 225 that are fixedly connected with respective lifting parts 222.

It can be understood that by utilizing the limit shaft 225 to penetrate the guide trough 2234 and fix the connection with the lifting part 222, and since the extension direction of the guide trough 2234 is parallel to the extension direction of the guide wall, the limit shaft 225 will not affect the lifting part 222 and the relative movement of the vertical adjustment component 223. In addition, the limit shaft 225 can form a constraint between the vertical adjustment component 223 and the lifting part 222, such that when the lifting part 222 is not driven by the adjustment actuator 221, the vertical adjustment component 223 will not move relative to the lifting part 222 in the vertical direction.

It should be noted that the television is installed and used on the suspension device 300, and the suspension device 300 is hung on the fixed wall panel 302 through the hanging arm component 310. When the television needs to be disassembled, the entire television needs to be lifted upward first, and then pulled out laterally to separate the hanging arm component 310 from the wall panel 302. However, when the limit shaft 225 is not configured, in the process of lifting the television as a whole, the vertical adjustment component 223 first moves upward together with the television (installation component 330). However, when the vertical adjustment component 223 initially moves upward, it does not drive the lifting part 222, the adjustment actuator 221 and the hanging arm component 310 to rise together. Due to the limited viewing angle of people, this process may make people mistakenly think that the hanging arm component 310 has been separated from the wall panel 302. If horizontal force is applied at this time, it will cause damage to wall panel 302, suspension device 300 or television.

In the suspension device 300 of the present disclosure, by setting the limit shaft 225, during the actual process of lifting the television upward, the vertical adjustment component 223 will rise with the television, and under the action of the limit shaft 225, the vertical adjustment component 223 will directly drive the lifting part 222 and the adjustment actuator 221 to rise together, such that the adjustment actuator 221 drives the hanging arm component 310 to rise together. In this way, the consistency of movement of the hanging arm component 310 and the television can be ensured, which is helpful for the disassembly personnel to know whether the hanging arm component 310 has been separated from the wall panel 302, which reduces the risk of damage to the wall panel 302, suspension device 300 or the TV caused by the operator pulling out the TV laterally when the hanging arm component 310 and the wall panel 302 are not completely separated.

Specifically, there are two guide troughs 2234 on the vertical adjustment component 223, one of which is the first guide trough 22341, the other guide trough 2234 is the second guide trough 22342. The extension direction of the first guide trough 22341 is parallel to the first guide wall 22211A, and the extension direction of the second guide trough 22342 is parallel to the extension direction of the first guide wall 22211B; there are two limit shafts 225, one of which is the first limit shaft 2251, the other is the second limit shaft 2252. The first limit shaft 2251 is movably installed in the first guide trough 22341 and has a fixed connection with the first lifting part 2221. The second limit shaft 2252 is movably installed in the second guide trough 22342 and has a fixed connection with the second lifting part 2222.

It should be noted that the first limit shaft 2251 and the second limit shaft 2252 are both screws, the first lifting part 2221 is configured with a first screw hole, the second lifting part 2222 is configured with a second screw hole. The first limit shaft 2251 is inserted through the first guide trough 22341 through the first screw hole, and there is a gap between the screw head of the first limit shaft 2251 and the vertical adjustment component 223, that is, the first limit shaft 2251 is not locked on the vertical adjustment component 223, and the first limit shaft 2251 can move along the first guide trough 22341; the second limit shaft 2252 is inserted through the second guide trough 22342 through the second screw hole, and there is a gap between the screw head of the second limit shaft 2252 and the vertical adjustment component 223, that is, the second limit shaft 2252 is not locked on the vertical adjustment component 223, and the second limit shaft 2252 can move along the second guide trough 22342.

As shown in FIG. 16 and FIG. 17, in some examples, the vertical adjustment component 223 is configured with a guide channel 2235 extending vertically, the hanging arm component 310 is fixed with a guide shaft 226, and the guide shaft 226 is installed in the guide channel 2235. The guide shaft 226 can guide the vertical adjustment component 223 in the vertical direction, thereby improving the movement accuracy of the vertical adjustment component 223.

In some other examples, the guide shaft 226 can also be fixed on the vertical adjustment component 223, and the guide channel 2235 can also be set on the hanging arm component 310.

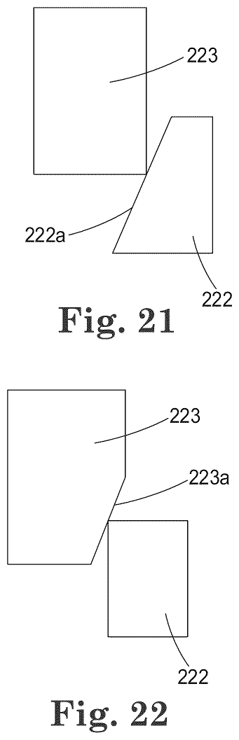

It should be noted that the cooperative mode of lifting part 222 and vertical adjustment component 223 are not limited to the above. In some examples, as shown in FIG. 21, only a single lifting part 222 is utilized and configured with a guide wall (first guide wall 222a), the vertical adjustment component 223 engages the guide wall on the lifting part 222, and there is no guide wall on the adjustment component 223. In other examples, as shown in FIG. 22, only the vertical adjustment component 223 is configured with a guide wall (second guide wall 223a), and a single lifting part 222 engages the guide wall on the vertical adjustment component 223, but there is no guide wall configured on the lifting part 222; in these examples, the adjustment actuator 221 can also drive the lifting part 222 such that the vertical adjustment component 223 moves along the extension direction of the guide wall relative to the lifting part 222 and the vertical adjustment component 223 moves in the vertical direction relative to the hanging arm component 310.

As shown in FIG. 16, in some examples, the installation component 330 includes an installation part 231 and a connection unit 232. The connection unit 232 is used to connect the installation part 231 and the hanging arm component 310.

Specifically, the connection unit 232 is used for the connection installation part 231 and the vertical adjustment component 223.

When the vertical adjustment component 223 rises, it can drive the connection unit 232 to rise, thereby driving the installation part 231 to rise. When the vertical adjustment component 223 lowers, it can drive the connection unit 232 to lower, thereby driving the installation part 231 to lower. Among them, installation part 231 is used to install the television, such that the level of the television can be adjusted when the vertical adjustment component 223 is raised and lowered.

Referencing FIG. 16 and FIG. 17, connection unit 232 includes the first connection part 2321 and the second connection part 2322. The first connection part 2321 and second connection part 2322 are cross-configured. The first connection part 2321 and the second connection part 2322 are rotatably connected. The higher end of the first connection part 2321 and the vertical adjustment component 223 are rotatably connected. The lower end of the first connection part 2321 and the installation part 231 are rotatably connected, and the lower end of the first connection part 2321 can move in a vertical direction relative to the installation part 231. The higher end of the second connection part 2322 and the installation part 231 are rotatably connected. The lower end of the second connection part 2322 is rotatably connected to the hanging arm component 310. In addition, the lower end of the second connection part 2322 can move in a vertical direction relative to the hanging arm component 310.

It can be understood that the connection unit 232 can be unfolded and folded (e.g., extended and collapsed) to control the distance between the television and the wall panel 302 so as to adjust the distance between the television and the user.

Further, the installation component 330 also includes a connecting frame 233 fixed on the installation part 231, the lower end of the first connection part 2321 is rotatably connected to the connecting frame 233, and the lower end of the first connection part 2321 can move in a vertical direction relative to the connecting frame 233. The higher end of the second connection part 2322 and the connecting frame 233 are rotatably connected.

It should be noted that the specific structure of the connection unit 232 is not limited to the above.

In the television hanging rack of the present disclosure, the wall panel 302 may be fixed on the wall, the hanging arm component 310 is hung on the wall panel 302, and the installation component 330 is used to connect the display device; after the display device is installed on the installation component 330, if the display device tilting occurs, the adjustment actuator 221 can be controlled such that the adjustment actuator 221 drives the lifting part 222 and the vertical adjustment component 223 moves relative to the lifting part 222 along the extension direction of the guide wall, such that the vertical adjustment component 223 moves in a vertical direction relative to the hanging arm component 310, such that the vertical adjustment component 223 drives the installation component 330 to move in a vertical direction relative to the hanging arm component 310, thereby adjusting the level of the display device. In the television hanging rack of the present disclosure, when the display device is tilted due to the installation tilt of the wall panel 302, the adjustment component 320 can be used to adjust the level of the display device without removing the wall panel 302, which is easy to operate.

In the description of this specification, a description referring to the terms “one example,” “some examples,” “schematic examples,” “examples,” “specific examples,” or “some examples,” means that a specific feature, structure, material, or characteristic described in connection with the example or typical example is included in at least one example or example of the present disclosure. In the present specification, schematic representations of the above terms are not necessarily referring to the same example or typical example. Moreover, the specific features, structures, materials, or features described may be combined in any one or more examples or examples in a suitable manner.

Although examples of the present disclosure have been shown and described, those of ordinary skill in the art may understand that: Various changes, modifications, substitutions and variations can be made to these examples without departing from the principles and objectives of the present disclosure, and the scope of the present disclosure is defined by the claims and their equivalents.

The examples of the present disclosure are described in detail above in conjunction with the attached drawings, but the present disclosure is not limited to the above examples, and various changes can also be made without departing from the purpose of the present disclosure within the scope of knowledge possessed by those of ordinary skill in the art. Furthermore, examples and features of examples of the present disclosure may be combined with each other without conflict.

Having thus described the present invention in detail, it is to be appreciated and will be apparent to those skilled in the art that many physical changes, only a few of which are exemplified in the detailed description of the invention, could be made without altering the inventive concepts and principles embodied therein.

It is also to be appreciated that numerous embodiments incorporating only part of the preferred embodiment are possible which do not alter, with respect to those parts, the inventive concepts and principles embodied therein.

The present embodiment and optional configurations are therefore to be considered in all respects as exemplary and/or illustrative and not restrictive, the scope of the invention being indicated by the appended claims rather than by the foregoing description, and all alternate embodiments and changes to this embodiment which come within the meaning and range of equivalency of said claims are therefore to be embraced therein.

What is claimed is:

1. A system for mounting a display comprising:
at least one hanger assembly arranged in a vertical direction, the hanger assembly comprising:
a hook assembly configured to engage a wall panel, the hook assembly comprising a support surface extending in a first direction; and
a movable hanger configured to slidably engage with the hook assembly, such that the movable hanger slides in a vertical direction, and wherein the movable hanger is configured to receive the display;
an adjustment assembly comprising:
at least one adjustment component, the adjustment component including an abutment surface configured to slidably engage with the support surface of the hook assembly; and
an adjustment actuator that engages the at least one adjustment component, such that when actuated, the adjustment actuator translates in a direction transverse to the vertical direction to drive the adjustment component to also translate in the transverse direction relative to the movable hanger and the movable hanger to translate in the vertical direction,
wherein when the adjustment component is driven the abutment surface of the adjustment component slides along the support surface in the first direction.

2. The system of claim 1, wherein the at least one hanger assembly is a single hanger assembly and the hook assembly includes an upper hook configured to engage a hook ledge of the wall panel.

3. The system of claim 1, wherein the at least one adjustment component is a single adjustment component, wherein the adjustment actuator is a threaded fastener configured to be received by a threaded nut fastened to a side of the hanger assembly, and wherein the threaded fastener is secured to the adjustment component, such that when the threaded fastener is rotated, the threaded fastener and adjustment component translate in a direction transverse to vertical.

4. The system of claim 1, wherein:
the one or more adjustment components includes two adjustment components,
the adjustment actuator includes a threaded fastener,
the two adjustment components are actuated by the threaded fastener to translate along a horizontal axis,
the two adjustment components are threaded in opposite directions to translate in opposite directions along the horizontal axis to increase or decrease a space between the two adjustment components,
one or more guide walls of the two adjustment components abut a vertical adjustment component and slidably engage the vertical adjustment component as the two adjustment components translate horizontally,
the vertical adjustment component is configured to rise vertically as the one two adjustment components translate horizontally to decrease the space, and
the vertical adjustment component is configured to lower as the two adjustment components translate horizontally to increase the space.

5. The system of claim 1, wherein the hook assembly comprises an upper end and a lower end, the upper end including an upper hook configured to attach to the hook ledge, the lower end configured to connect with or abut a wall panel.

6. The system of claim 1, wherein a wear-reducing piece or wear-reducing layer is provided between the support surface and the abutment surface.

7. The system of claim 1, wherein the adjustment actuator extends in the horizontal direction, the one or more adjustment components are slidable in the horizontal direction relative to the movable hanger, and an angle of the first direction and the vertical direction is greater than 0 degrees and less than 90 degrees, wherein the first direction extends along an interface between the support surface and the abutment surface adjustment component is driven.

8. The system of claim 1, wherein the movable hanger has a first stop slot with at least one of the one or more adjustment components and the other is provided with a first stop, the first stop is at least partially housed in the first stop slot and movable inside the first stop slot, and the extension direction of the first stop slot is the same as the extension direction of the one or more adjustment components.

9. The system of claim 1, wherein the hook assembly has a second stop slot with one of the movable hangers and the other is provided with a second stop, the second stop being at least partially housed in the second stop slot and movable inside the second stop slot and the second stop slot extending in the vertical direction.

10. The system of claim 7, wherein the at least one hanger assembly further comprises an elastic piece having an elastic piece first end and an elastic piece second end, the elastic piece first end and the elastic piece second end being respectively connected to the movable hanger and a coupling mechanism, wherein the coupling mechanism is configured to be snap-connected to the coupling mechanism under an elastic force of the elastic piece.

11. The system of claim 10, wherein the wall panel further comprises a first hook ledge and a second hook ledge located below the first hook ledge, wherein the upper hook is configured to couple to the first hook ledge, wherein the hook assembly further comprising a lower hook that is configured to couple to second hook ledge.

12. The system of claim 1, wherein the system further comprises an adjustment arm connected to the movable hanger, wherein the adjustment arm is configured to mount to a television.

13. A system for mounting a display comprising:
at least one hanging arm component arranged in a vertical direction for hanging on a wall panel;
an adjustment component configured to control a vertical adjustment of the hanging arm component, the adjustment component including an adjustment actuator coupled to the at least one hanging arm component, a lifting part that is driven and matched with an adjustment actuator and at least one vertical adjustment component; and
an installation component configured to couple to the display device, wherein the installation component is driven by the vertical adjustment component as the lifting part engages the adjustment actuator and drives translation of the vertical adjustment component,
wherein, at least one of the lifting part and vertical adjustment component and the at least one vertical adjustment component has a guide wall,
wherein the lifting part and vertical adjustment component and the at least one vertical adjustment component are guided and cooperated by the guide wall,
wherein the extension direction of the guide wall intersects with a vertical direction and is not vertical,
wherein vertical adjustment component and the at least one vertical adjustment component can be driven by the adjustment actuator to move along the extension direction of the guide wall relative to the lifting part such that vertical adjustment component and the at least one vertical adjustment component moves in the vertical direction relative to the hanging arm component.

14. The system of claim 13, wherein vertical adjustment component and the at least one vertical adjustment component also has a guide wall, and the guide wall on vertical adjustment component and the at least one vertical adjustment component includes a first guide wall and a second guide wall arranged on a side opposite of the first guide wall, wherein the first guide wall gradually tilts away from the second guide wall from a bottom side to a top side, and the second guide wall gradually tilts away from the first guide wall from the bottom side to the top side.

15. The system of claim 13, wherein the adjustment component further comprises a guide configured on the hanging arm component and extending in the horizontal direction, wherein and the first lifting part and the second lifting part are installed on the guide.

16. The system of claim 15, wherein the adjustment actuator is inserted through the first lifting part and the second lifting part, and the adjustment actuator is configured to be driven by rotating around its central axis.

17. A method for adjusting a vertical height of a movable hanger on a wall comprising:
providing a system for mounting a display on a wall comprising:
at least one hanger assembly arranged in a vertical direction; and
an adjustment assembly, the adjustment assembly comprising:
one or more adjustment components including an abutment surface extending in a first direction; and
an adjustment actuator, the adjustment actuator configured to extend along a direction transverse to the vertical direction, wherein the one or more adjustment components are slidably engaged to the movable hanger and abut the hook assembly
slidably engaging the movable hanger to abut the hook assembly, using the adjustment actuator; and
driving one or more adjustment components to move relative to the hook assembly in the first direction to slide the movable hanger relative to the hook assembly in the vertical direction.

18. The method of claim 17, wherein the one or more hanger assemblies comprise a single hanger assembly positioned on one of a first end or a second of the hook ledge (210).

19. The method of claim 17, wherein the one or more adjustment components comprise a single adjustment component.

20. The method of claim 17, wherein:
the one or more adjustment components includes two adjustment components,
the two adjustment components translate horizontally to increase or decrease a space between the two adjustment components,
one or more guide walls of the two adjustment components abut a vertical adjustment component and slidably engage the vertical adjustment component as the two adjustment components translate horizontally,
the vertical adjustment component is configured to rise vertically as the one two adjustment components translate horizontally to decrease the space, and
the vertical adjustment component is configured to lower as the two adjustment components translate horizontally to increase the space.
